(19) United States
(12) Patent Application Publication
(10) Pub. No.: US 2015/0074821 A1
(43) Pub. Date: Mar. 12, 2015

(54) DEVICE MANAGEMENT APPARATUS, DEVICE MANAGEMENT SYSTEM AND DEVICE MANAGEMENT METHOD

(71) Applicant: Daiki HOSHI, Tokyo (JP)

(72) Inventor: Daiki HOSHI, Tokyo (JP)

(73) Assignee: RICOH COMPANY, LTD., Tokyo (JP)

(21) Appl. No.: 14/464,823

(22) Filed: Aug. 21, 2014

(30) Foreign Application Priority Data
Sep. 10, 2013 (JP) 2013-187602

(51) Int. Cl. G06F 21/10; G06F 21/12

(52) U.S. Cl. CPC G06F 21/105; G06F 21/121
USPC 726/27

(57) ABSTRACT

A device management apparatus includes a first storage part storing license information regarding a license of an application for each of a plurality of devices and a processor executing a program to perform a license validating process and a function restricting process. The license validating process changes, when the license information includes invalidity information indicating that the license is invalid, the invalidity information into validity information indicating that the license is valid. The function restricting process restricts, when the license information includes the invalidity information, an execution of a function of the device management apparatus with respect to the application of each of the devices.

### CROSS-REFERENCE TO RELATED APPLICATION

The present application is based upon and claims the benefit of priority of Japanese Patent Application No. 2013-187602, filed on Sep. 10, 2013, the entire contents of which are incorporated herein by reference.

### BACKGROUND OF THE INVENTION

1. Field of the Invention

The present invention generally relates to a device management apparatus.

2. Description of the Related Art

There is known, for example, as disclosed in Japanese Laid-Open Patent Application No. 2008-016013, a method of preventing unauthorized use of an application. According to this method, an activation is performed on an application installed in a device, and if a valid license is provided, information indicating that a use of the application is authorized is written in the device to prevent the application from being illegally used. When an activation of the application is performed, the device communicates with external activation server in order to check whether an effective license is provided.

In the above-mentioned method, when the device cannot communicate with the external activation server, the activation cannot be performed. Especially in companies, there are many cases where a prohibition of an access from a device to an external network is set as a security policy in order to secure the company's security. In such a case, for example, a method of manually inputting an activation key to a device to be activated may be used, which increases a number of operations of a user.

### SUMMARY OF THE INVENTION

There is provided according to an aspect of the present invention a device management apparatus including a first storage part storing license information regarding a license of an application for each of a plurality of devices and a processor executing a program to perform a license validating process and a function restricting process, wherein the license validating process changes, when the license information includes invalidity information indicating that the license is invalid, the invalidity information into validity information indicating that the license is valid, and the function restricting process restricts, when the license information includes the invalidity information, an execution of a function of the device management apparatus with respect to the application of each of the devices.

There is provided according to another aspect of the present invention a device management method of a device management apparatus connected to a plurality of devices through a network, the device management method including changing, when license information stored for each of the devices includes invalidity information indicating that the license is invalid, the invalidity information into validity information indicating that the license is valid and restricting, when the license information includes the invalidity information, an execution of a function of the device management apparatus with respect to an application of each of the devices.

There is provided according to a further aspect of the present invention a device management system including: a plurality of devices; a first storage part storing license information regarding a license of an application for each of the plurality of devices; and a computer connected to the devices through a network, the computer executing a program to perform a license validating process and a function restricting process, wherein the license validating process changes, when the license information includes invalidity information indicating that the license is invalid, the invalidity information into validity information indicating that the license is valid, and the function restricting process restricts, when the license information includes the invalidity information, an execution of a function of the computer with respect to the application of each of the devices.

Other objects, features and advantages of the present invention will become more apparent from the following detailed description when read in conjunction with the accompanying drawings.

The objects and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is an illustration of a device management system according to an embodiment;

FIG. 2 is a block diagram of a hardware structure of the device management system;

FIG. 3 is a functional block diagram of the device management system;

FIG. 4 is an illustration of an example of device license information;

FIG. 5 is an illustration of an example of usable license information;

FIG. 6 is a sequence chart of a license validating process;

FIG. 7 is a sequence chart of a function executing process;

FIG. 8 is an illustration for indicating a state of license assignment; and

FIG. 9 is a flowchart of a license assigning process.

### DETAILED DESCRIPTION OF THE PREFERRED EMBODIMENTS

A description will now be given, with reference to the drawings, of a device management system according to an embodiment of the present invention.

<System Structure>

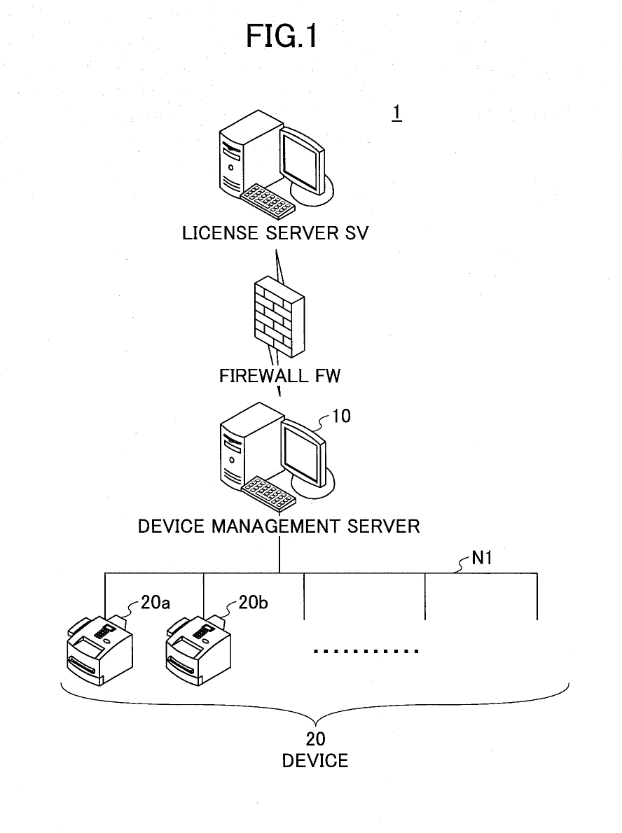

FIG. 1 is a structure diagram of a device management system according to an embodiment. The device management system 1 illustrated in FIG. 1 includes a license server SV, a firewall FW, a device management server 10 and a plurality of devices 20a, 20b, . . . (hereinafter, may be collectively referred to as a device 20). The device management server 10 is connected to the device 20 through a network N1. The device management server 10 is connected to the license server SV through an external network such as the Internet or the like. The firewall FW is installed between the device management server 10 and the license server SV.

The network N1 is, for example, a local area network (LAN). The network N1 is a private network, and the device 20 cannot make an access to the license server SV.

The device management server 10 is materialized by an information processing apparatus (computer) mounted with a general purpose operating system (OS). The device management server 10 includes a personal computer (PC), a tablet PC, a notebook PC, a smartphone, a cellular phone, etc. The device management server 10 has information regarding a license of an application in order to perform a license management of applications to be installed or already installed in the device 20. The device management server 10 is capable of installing an application to the device 20 and setting an application already installed in the device 20. The device management server 10 restricts the above-mentioned installation and setting of an application according to the validity (whether valid or invalid) of the license of the application.

The device 20 includes a display device such as a multi-function peripheral (MFP), a copy machine, a scanner, a laser printer, a projector, etc. The device 20 is capable of installing/uninstalling an application. Additionally, the device 20 is capable of executing an installed application.

The license server SV includes a computer managed by a bender of applications, and has information regarding licenses of applications.

The firewall FW restricts access between an external network such as the Internet and the private network N1. In the present embodiment, it is assumed that the device 20 cannot access the license management server due to the restriction by the firewall FW.

It should be noted that although the single device management server 10 is illustrated in FIG. 1, a plurality of the management servers 10 may be used. Additionally, the license server SV and the firewall FW are not essential structural elements, and there may be a case where the device management system 1 does not include the license server SV and/or the firewall FW.

<Hardware Structure>

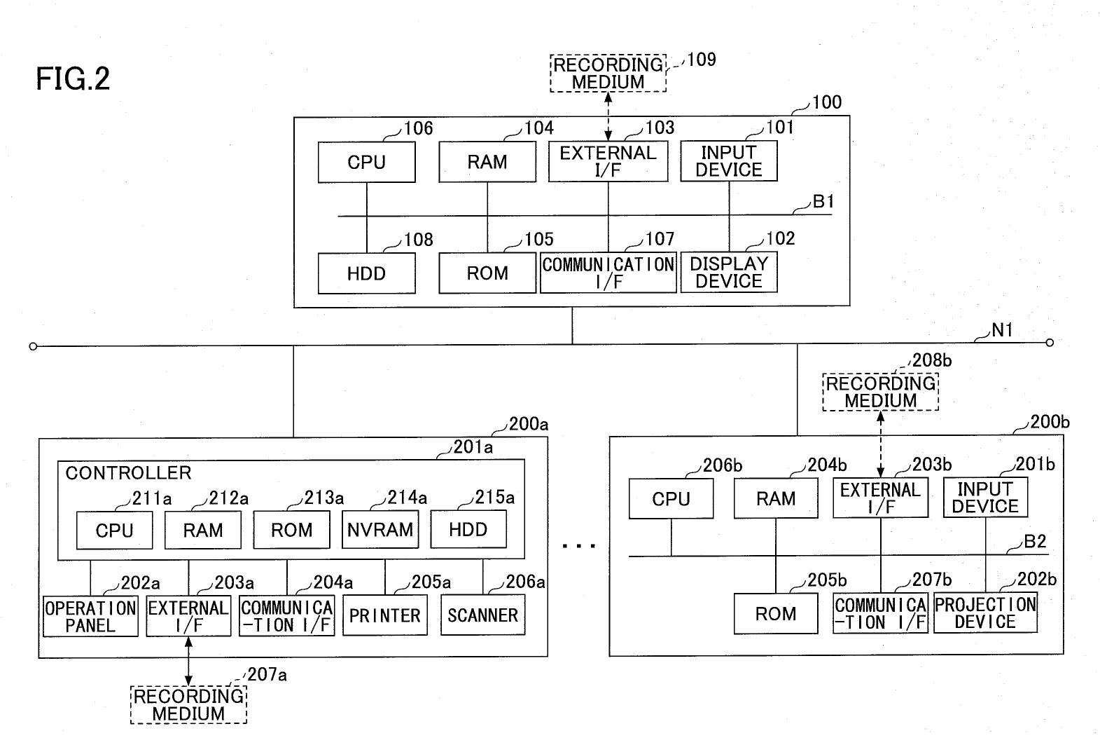

FIG. 2 is a block diagram of a hardware structure of the device management system 1 according to the present embodiment.

The device management server 10 illustrated in FIG. 1 includes a computer 100 having a hardware structure illustrated in FIG. 2. The computer 100 illustrated in FIG. 2 includes an input device 101, a display device 102, an external interface (I/F) 103, a random access memory (RAM) 104, a read only memory (ROM) 105, a central processing unit (CPU) 106, a communication interface (I/F) 107 and a hard disk drive (HDD) 108 that are mutually connected by a bus B1.

The input device 101 includes a keyboard, a mouse, a touch panel, etc., to input operation signals to the computer 100.

The display device 102 includes a liquid crystal display (LCD), a cathode ray tube (CRT), etc., to display a result of processing by the computer 100.

The external I/F 103 is an interface with external devices. The external devices include a recording medium 109 and the like. The recording medium 109 is capable of storing programs executed by the computer 100 to materialize the device management server 10 according to the present embodiment. The computer 100 is capable of reading/writing information from/on the recording medium 109.

As for the recording medium 109, a computer readable recording medium such as a universal serial bus memory (USB memory), an SD memory card, a digital versatile disk (DVD), a compact disk (CD), a flexible disk, etc., can be used.

The RAM 104 is a volatile semiconductor memory (storage device), which is capable of temporarily storing programs and data.

The ROM 105 is a non-volatile semiconductor memory (storage device), which is capable of retaining programs and data even when a power is turned off. Stored in the ROM 105 are programs and data for basic input/output system (BIOS) setting, operating system (OS) setting and network setting, which are executed when booting up the computer 100.

The CPU 106 is an operation unit to materialize a control and function of the entire computer 100 by reading programs and data from a storage device, such as the ROM 105 and the HDD 108, and storing the read programs and data to the RAM 104 in order to perform a process by executing the programs.

The communication I/F 107 is an interface to connect to a network. The computer 100 can perform data communication through the communication I/F 107. The data communication by the communication I/F 107 may be a wired communication or a wires communication.

The HDD 108 is a non-volatile storage device for storing programs and data. Programs and data stored in the HDD 108 include, for example, an operating system (OS), which is basic software to control the entire computer 100, and application software to provide various functions on the OS. The HDD 108 manages the stored programs and data according to a predetermined file system and/or database (DB).

The device management server 10 according to the present embodiment can materialize various processes mentioned later by executing programs by the computer 100 having the above-mentioned hardware structure.

The device 20 illustrated in FIG. 1 can be materialized by the device 200a or 200b having the hardware structure illustrated in FIG. 2. The device 200a illustrated in FIG. 2 includes a controller 201a, an operation panel 202a, an external I/F 203a, a communication I/F 204a, a printer 205a and a scanner 206a. The controller 201a includes a CPU 211a, a RAM 212a, a ROM 213a, an NVRAM 214a and an HDD 215a.

The ROM 213a stores various programs and data. The RAM 212a temporarily stores programs and data. The NVRAM 214a stores, for example, setting information. The HDD 215a stores various programs and data.

The CPU 211a materializes a control and function of the entire device 200a by performing processes by reading programs and data from the ROM 213a, the NVRAM 214a and the HDD 215a and storing the read programs and data in the RAM 212a.

The operation panel 202a is provided with an input part for receiving an input from a user and a display part for displaying information. The external I/F 203a is an interface with external devices including a recording medium 207a. The device 200a is capable of reading/writing information from/onto the recording medium 207a through the external I/F 203a. As for the recording medium 207a, a computer readable recording medium such as an IC card, a flexible disk, a CD, a DVD, an SD card, a USB memory, etc., may be used.

The communication I/F 204a is an interface to connect the device 200a to the network N1. The device 200a can perform data communication through the communication I/F 204a. The data communication by the communication I/F 204a may be a wired communication or a wires communication.

The printer 205a is a printing device for printing print data on a print paper. The scanner 206a is a reading device for reading an image on an original document to create image data.

The device 200b illustrated FIG. 2 includes an input device 201b, an projection device 202b, an external I/F 203b, a RAM 204b, a ROM 205b, a CPU 206b and a communication I/F 207b that are mutually connected by a bus B2.

The input device 201b is used for inputting various operation signals to the device 200b.

The projection device 202b is used to project a still image or a moving image onto a screen.

The external I/F 203b, the RAM 204b, the ROM 205b, the CPU 206b and the communication I/F 207b are the same as the external I/F 203a, the RAM 212a, the ROM 213a, the CPU 211a and the communication I/F 204a of the device 200a, and descriptions thereof will be omitted.

The device 20 according to the present embodiment including the devices 200a and 200b each having the above-mentioned hardware structure is capable of materialize various processes mentioned below.

<Software Structure>

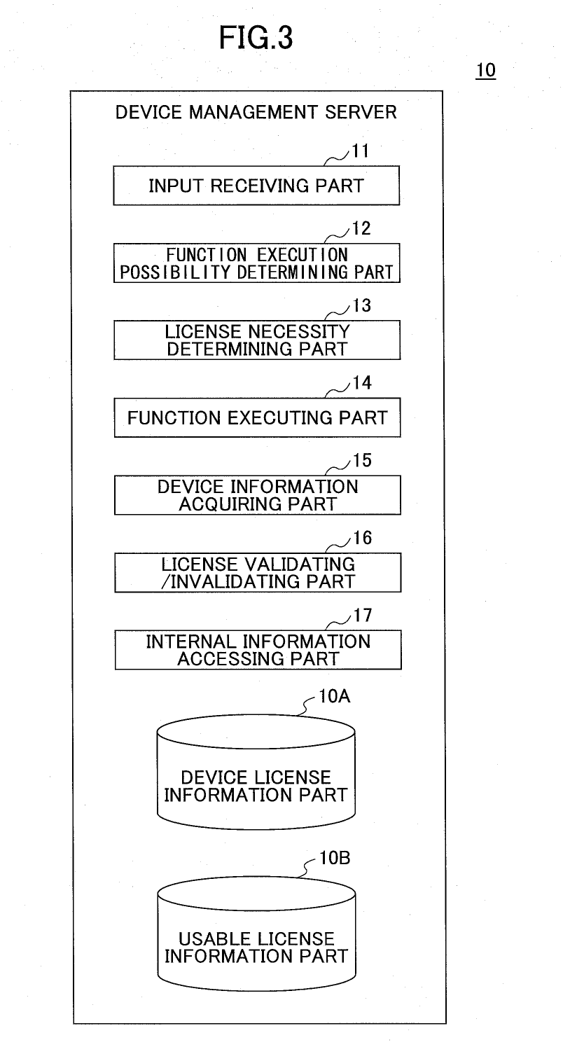

The device management server 10 according to the present embodiment can be materialized by the processes illustrated in FIG. 3. FIG. 3 is a process block diagram of the device management server 10 according to the present embodiment.

The device management server 10 includes an input receiving part 11, a function execution possibility determining part 12, a license necessity determining part 13, a function executing part 14, a device information acquiring part 15, a license validating/invalidating part 16 and an internal information accessing part 17. Each of these parts can be materialized by using a storage device connected to the HDD 108 or the device management server 10 through a network.

The input receiving part 11 receives information input by an operation of a user performed on a keyboard, a mouse or a touch panel. The input receiving part 11 also requests other processing parts to perform a process in accordance with information input by a user.

The function execution possibility determining part 12 determines, when performing a function on a designated device 20, whether or not the function can be performed. For example, when the device management server 10 installs an application in the device 20 designated by a user, the function execution possibility determining part 12 determines whether the installation of the application is executable.

The license necessity determining part 13 determines, when a process is performed on a designated device 20, whether a license is necessary. For example, when the device management server 10 installs an application in the device 20 designated by a user, the license necessity determining part 13 determines whether a license is necessary.

The function executing part 14 performs a function. Here, the function is, for example, an installation/uninstallation of an application, an environment setting function of an application or the like. That is, the device management server 10 performs an installation/uninstallation of an application or an environment setting of an installed application on the device 20.

The device information acquiring part 15 acquires various kinds of information from the device 20. For example, device information acquiring part 15 acquires information regarding whether an application is installed in the device 20.

The license validating/invalidating 16 performs validation/invalidation of a license for an application installed in the device 20.

The internal information accessing part 17 accesses a device license information part 10A and a usable license information part 10B to write data in the device license information part 10A and the usable license information part 10B.

The device license information part 10A manages license information of the application installed in the device 20. That is, the device license information part 10A manages a list of applications and validation/invalidation of each application with respect to each device 20.

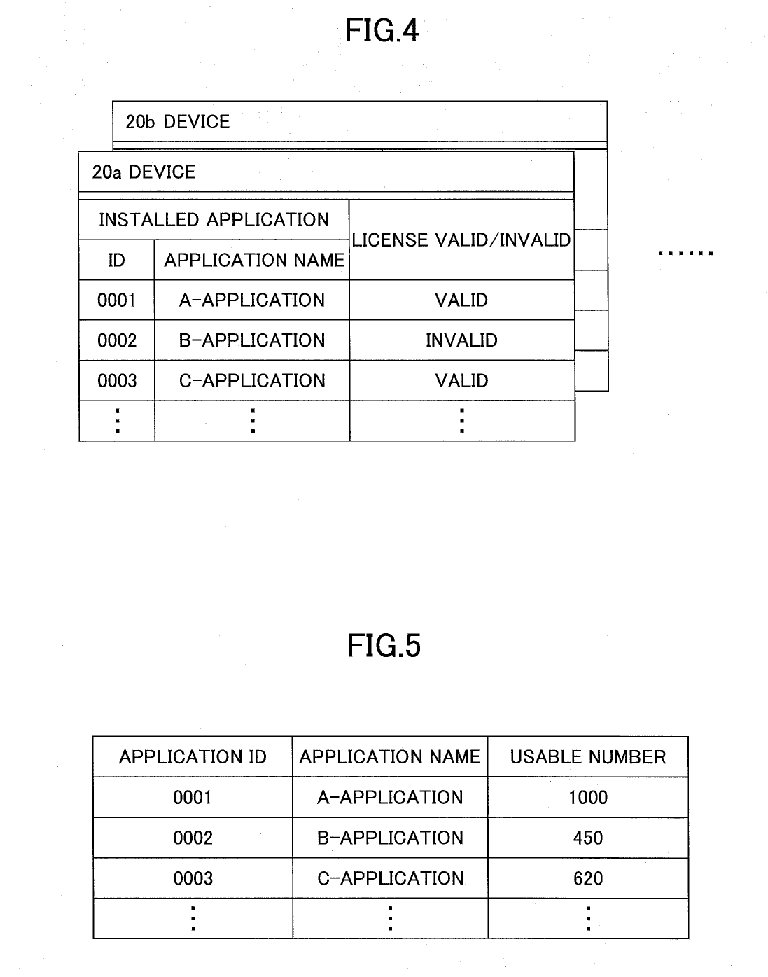

A description is given below of the device license information stored in the device license information part 10A. FIG. 4 is an illustration illustrating an example of the device license information according to the present embodiment.

In the example illustrated in FIG. 4, whether a license is valid or invalid is indicated for each of the applications installed in the device 20a. Specifically, FIG. 4 illustrates that the license of an A-application (ID0001) is valid, the license of a B-application (ID0002) is invalid, and the license of a C-application (ID0003) is valid. It should be noted that if a license of an application is invalid, an execution of the function of the device management server 10 with respect to the application of which license is invalid is restricted. For example, when the device management server 10 executes an environmental setting with respect to the B-application of the device 20a, the execution of the function is restricted because the license of the B-application of the device 20a is invalid. As for a method of restricting the execution of the function, there is considered a method of causing an environment setting to be unable to execute or a method of prohibiting setting of a part of items.

It should be noted that although validation/invalidation of the license is managed for each of the applications installed in the device 20 in the example of FIG. 4, validation/invalidation of the license of each of applications that are not installed in the device 20 may be manage. That is, for example, although a D-application is not installed in the device 20a, validation/invalidation of the license of the D-application may be managed.

The usable license information part 10B manages a total of a usable number of a license for each application. The usable number of a license indicates how many times the license can be validated, and a license of an application can be validated for the usable number of the license of that application. It should be noted that when the usable number of a license is zero, the application corresponding to the license cannot be validated.

A description is given below of the usable license information stored in the usable license information part 10B. FIG. 5 is an illustration illustrating an example of the usable license information.

FIG. 5 illustrates an example in which the usable numbers of the A-application (ID0001), B-application (ID0002) and C-application (ID0003) are 1000, 450 and 620, respectively. That is, according to the example of FIG. 5, is capable of validating the license of the A-application for 1000 devices 20

It should be noted that if a license of an application is newly purchased, it is desirable to cause the usable license information updated. For example, if a license of an application is newly purchased, a communication with the license server SV is performed to update the usable license information. Such an update of the usable license information may be carried out manually by a user, or may be carried out by performing a communication with the license server SV periodically or in a license validating process mentioned later.

<Process Details>

Next, a description will be given of details of processes performed by the device management system 1 according to the present embodiment.

First, a description is given of a process performed by the device management server 10 to validate a license of an application of the device 20. Hereinafter, a case of validating the license of the B-application of the device 20a is explained as an example.

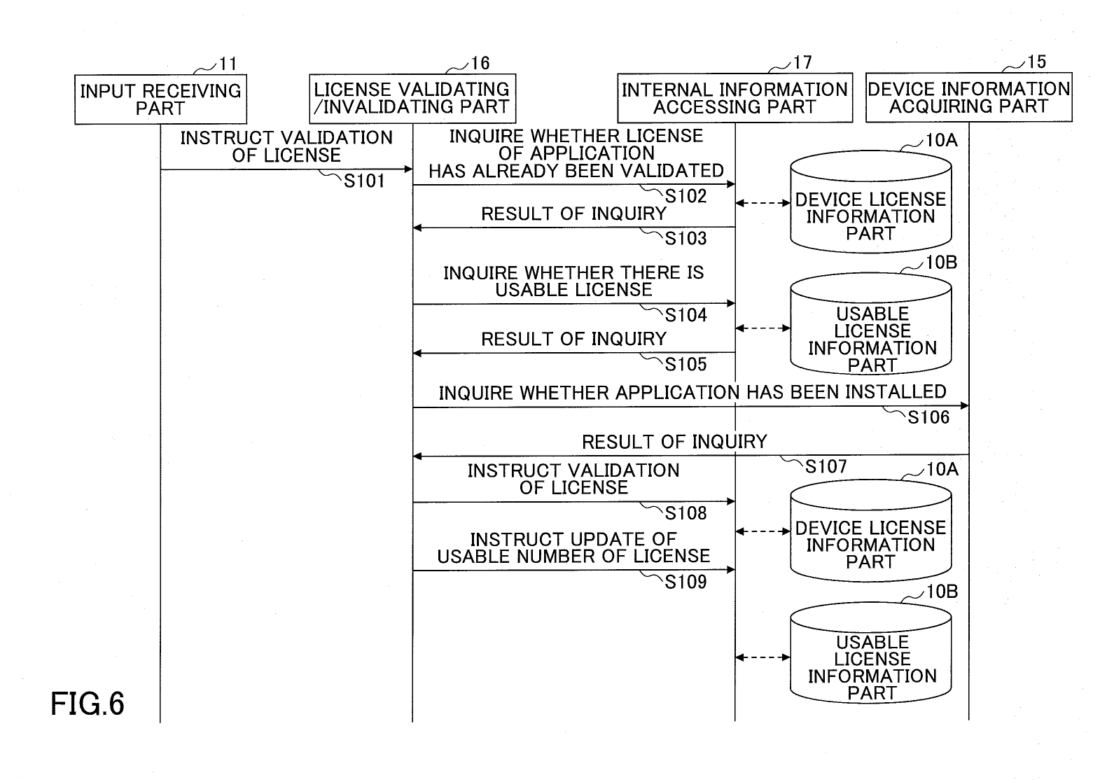

FIG. 6 is a sequence chart of a license validating process according to the present embodiment. A user designates the B-application, which is one of the applications of the device 20a, by an operation of the keyboard, mouse or touch panel of the device management server 10 to validate the license of the B-application.

The input receiving part 11 send an instruction to the license validating/invalidating part 16 to validate the license of the application of the device 20 designated by the user (step S101). That is, the input receiving part 11 instructs the license validating/invalidating part 16 to validate the license of the B-application, which is one of the applications installed in the device 20a.

The license validating/invalidating part 16 sends an inquiry to the internal information accessing part 17 as to whether the license of the application of the device 20 has already been validated (step S102). That is, the license validating/invalidating part 16 inquires the internal information accessing part 17 whether the license of the B-application of the device 20a has already been validated.

The internal information accessing part 17 refers to the device license information part 10A and sends information, as a reply to the inquiry, regarding whether the license of the application of the device 20 is valid to the license validating/invalidating part 16 (step S103). That is, the internal information accessing part 17 refers to the device license information part 10A (refer to FIG. 4) and sends information, as a reply to the inquiry, regarding invalidity of the license of the application of the device 20a to the license validating/invalidating part 16.

It should be noted that if the license of the application of the device 20 designated by the user has already been validated, the subsequent process is not performed and the process is ended. At this time, for example, information indicating that the license of the application of the device 20 is already valid may be displayed on the display device 102 of the device management server 10.

Next, the license validating/invalidating part 16 sends an inquiry to the internal information accessing part 17 as to whether there is a usable license for the application (step S104). That is, the license validating/invalidating part 16 sends an inquiry to the internal information accessing part 17 as to whether there is a usable license for the B-application

It should be noted that before the process of the step S104, the device management server 10 may communicates with the license server SV to update the information stored in the usable license information part 10B. Thereby, for example, it is prevented to make a determination that the usable number is zero because the license of the application has been purchased but the usable number of the purchased license has not been reflected in the usable license information part 10B.

The internal information accessing part 17 refers to the usable license information part 10B and sends a reply, as a result of the inquiry, as to whether there is a usable license for the application to the license validating/invalidating part 16 (step S105). That is, the internal information accessing part 17 refers to the usable license information part 10B (refer to FIG. 5) and sends a reply, as a result of the inquiry, to the license validating/invalidating part 16 that the license of the B-application is usable because the usable number of the license of the B-application is 1000.

It should be noted that if there is no usable license for the application designated by a user, the subsequent process is not performed and the process is ended. At this time, information indicating that there is no usable license for the application may be displayed on the display device 102 of the device management server 10.

The license validating/invalidating part 16 send an inquiry to the device information acquiring part 15 as to whether the application is installed in the device 20 (step S106). That is, the license validating/invalidating part 16 inquires the device information acquiring part 15 whether the B-application is installed in the device 20a.

The device information acquiring part 15 acquires information as to whether the application is installed in the device 20 from the device 20 and sends the information as a result of the inquiry to the license validating/invalidating part 16 (step S107). That is, the device information acquiring part 15 acquires information as to whether the application is installed in the device 20a from the device 20a and sends a result of the inquiry to the license validating/invalidating part 16.

If the application is not installed in the device 20, the subsequent process is not performed and the process is ended. At this time, for example, information indicating that the application is not installed in the device 20 may be displayed on the display device 102 of the device management server 10.

It should be noted that the method of acquiring the information regarding whether the application is installed in the device 20 can be materialized by acquiring information regarding a list of installed applications from the device 20.

If validation/invalidation of the licenses of installed application is managed for each device 20 in the device license information part 10A, the device information acquiring part 15 may acquire the information regarding whether the application is installed from the device license information part 10A.

The license validating/invalidating part 16 instructs the internal information accessing part 17 to validate the license of the application of the device 20. Then, the internal information accessing part 17 updates the valid/invalid indication of the license of the application of the device 20 in the device license information part 10A to “valid” (step S108). That is, the license validating/invalidating part 16 instructs the internal information accessing part 17 to validate the license of the B-application of the device 20a. Then, the internal information accessing part 17 updates the valid/invalid indication of the license of the B-application of the device 20a in the device license information part 10A to “valid”.

Then, the license validating/invalidating part 16 instructs the internal accessing part 17 to update the license usable number of the application. Then, the internal information accessing part 17 updates the license usable number of the application in the usable license information part 10B (step S109). That is, the license validating/invalidating part 16 instructs the internal information accessing part 17 to update the license usable number of the B-application. Then, the internal information accessing part 17 updates the usable number of the license of the B-application in the usable license information part 10B by decreasing the usable number by 1.

According to the above-mentioned process, the use can validates the license of the designated application of the designated device 20 by using the device management server 10. That is, even when the device 20 cannot communicate with the license server SV connected to an external network, the validation of the license of application of the device 20 can be performed by the device management server 10.

It should be noted if the license of the application of the device 20 is invalid, the function of the device management server 10 to install the application and/or perform an environment setting of the application is restricted as mentioned later. Thus, if the license of the application is invalid, the application is prevented from being illegally used.

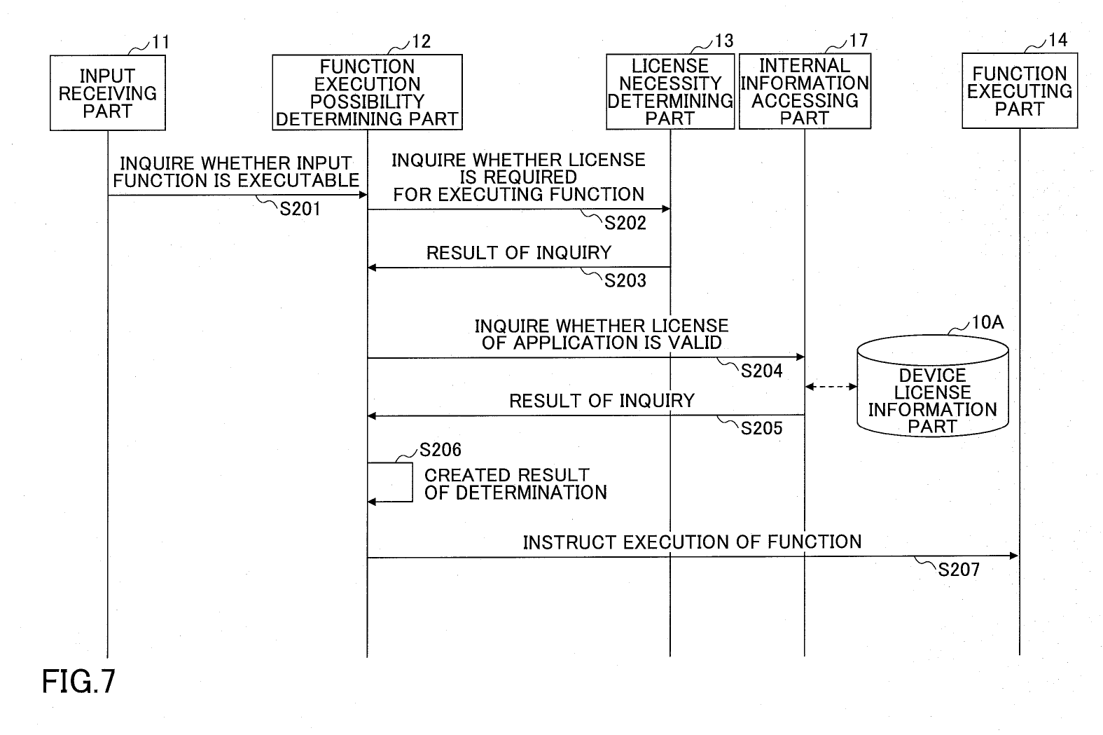

A description is given below of a process of the device management server 10 executing a function such as an installation of application, environment setting, etc. FIG. 7 is a sequence chart illustrating a function executing process according to the present embodiment. A description is given of a case where a user executes environment setting of the A-application of the device 20a by an operation of a keyboard, a mouse or a touch panel of the device management server 10.

The input receiving part 11 inquires the function execution possibility determining part 12 whether a function designated by a user is executable (step S201). That is, the input receiving part 11 sends an inquiry to the function execution possibility determining part 12 to ask whether environment setting of the A-application is executable.

Then, the function execution possibility determining part 12 inquires the license necessity determining part 13 whether a license is required for executing the function (step S202). That is, the function execution possibility determining part 12 sends an inquiry to the license necessity determining parts 13 to ask whether the license of the A-application is required to execute the environment setting of the A-application of the device 20a, that is, whether the license of the A-application is required to be valid.

Then, the license necessity determining part 13 sends a reply to the function execution possibility determining part 12 as a result of the inquiry whether the license is required for executing the function (step S203). That is, the license necessity determining part 13 replies that the license of the A-application is required to execute the environment setting of the A-application of the device 20a.

If the license is not required for the execution of the function, the process of the steps S204 to S205 is not performed and the process proceeds to step S206 mentioned later in which a determination result that the execution of the function is possible is created.

It should be noted that whether a license of an application is required for an execution of a function depends on each application. For example, an execution of a function of a standard application (for example, an application of a copy function) installed before delivery of the device 20 may be set that a license is not required. Additionally, for example, an execution of a function of an SDK application purchased from a software bender may be set that a license is required. Further, for example, the execution of an installation function of the SDK application may be set that a license is required, but an execution of environment setting may be set that a license is not required.

Next, the function execution possibility determining part 12 sends an inquiry to the internal information accessing part 17 to ask whether the license of the application is valid (step S204). That is, the function execution possibility determining part 12 sends an inquiry to the internal information accessing part 17 to ask whether the license of the A-application of the device 20a is valid.

Then, the internal information accessing part 17 refers to the device license information part 10A and sends a reply to the function execution possibility determining part 12 as a result of the inquiry whether the license of the application of the device 20 is valid (step S205). That is, the internal information accessing part 17 refers to the device license information part 10A (refer to FIG. 4) and sends a reply to the function execution possibility determining part 12 that the license of the A-application of the device 20a is valid.

If the license of the application of the device 20 is invalid, the process proceeds to step S206 where a determination result indicating that the license is invalid is created, and an execution of the function is not made. At this time, the display of the device management server 10 may be caused to display that the execution of the function cannot be made.

It should be noted that if the license of the application of the device 20 is invalid, the process of step S104 to step S109 of the above-mentioned license validating process may be performed so as to validate the license of the application. Additionally, the process of step S104 to step S109 of the license validating process may be performed so as to have the user to determine whether to validate the license of the application.

Then, the function execution possibility determining part 12 creates a determination result as to whether the execution of the function can be made (step S206). That is, the function execution possibility determining part 12 creates a determination result indicating that the environment setting of the A-application of the device 20a can be made.

If the determination result created in the process of step S206 indicates that the execution of the function can be made, the function execution possibility determining part 12 sends an instruction to the function executing part 14 to execute the function (step S207). That is, the function execution possibility determining part 12 instructs the function executing part 14 to execute the environment setting of the A-application of the device 20a.

If the determination result created by the process of step S206 indicates that the license is invalid, the process of step S207 is not performed.

Alternatively, if the determination result created by the process of step S206 indicates that the license is invalid, an execution of only a part of the function may be permitted in the process of step S207. That is, in the environment setting of the A-application of the device 20a, only a part of items among environment setting items may be permitted to be set.

According to the above-mentioned process, with respect to the application of the device 20 designated by the user, if the license of the application is not valid, an execution of a function can be restricted.

As the restriction applied to an execution of a function, it is considered that there is a case where an execution of functions is made impossible or a case where an execution of only a part of functions is permitted. The case where an execution of only a part of functions is permitted may include a case where setting of only a part of items is permitted or a case where an operation of a useful application (for example, saving a file or a connecting to a network) is restricted. If the license is not valid, an application is prevented from being illegally used by, for example, restricting an operation of the application.

Although an execution of the environment setting of the application was explained as an example of the execution of the function in the above-mentioned function executing process, there may be various functions for the function to be executed. For example, there may be a function of installing an application in the device 20, a function of uninstalling the application of the device 20, a function of executing an application of the device 20, and the like.

If the device management server 10 installs/uninstalls an application in the device 20, the installation/uninstallation can be made by distributing a corresponding installation file or the like stored in the HDD 108 of the device management server 10 to the device 20.

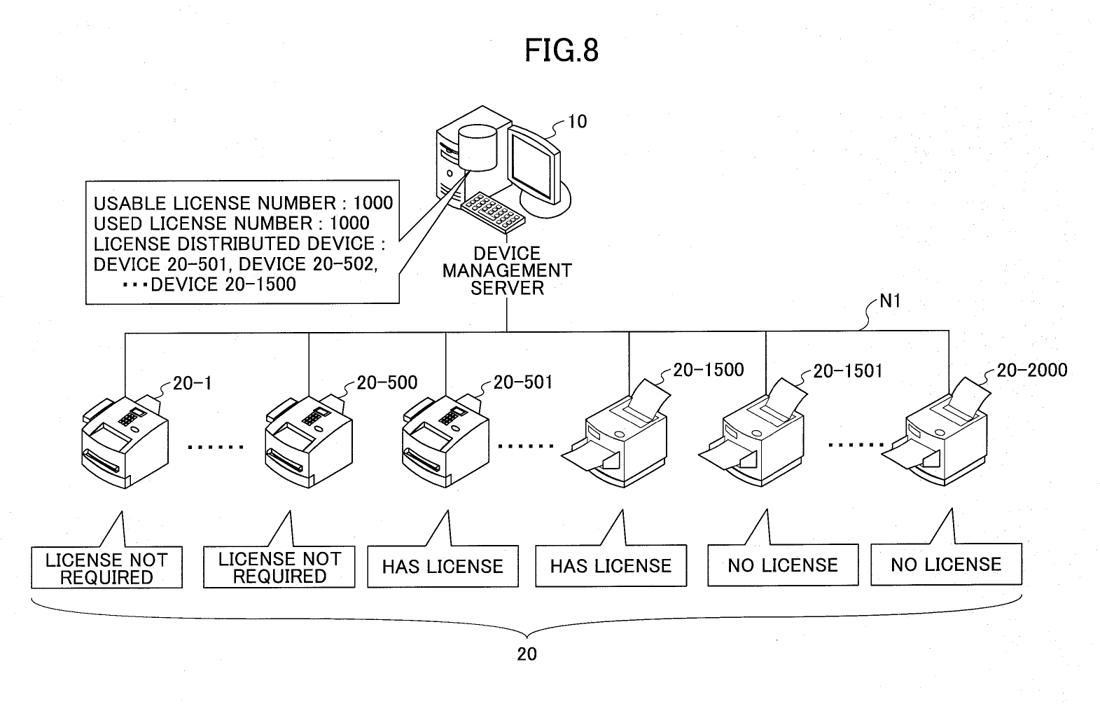

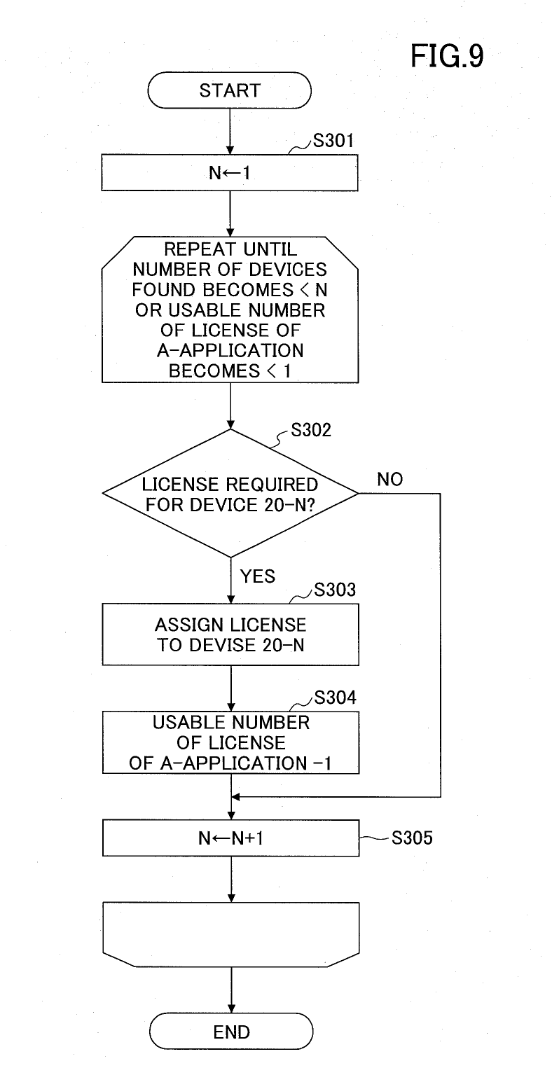

A description is given of a process of the device management server 10 assigning a license to a plurality of devices 20. Here, the assigning a license to the device 20 corresponds to validating a license of an application of the device 20. FIG. 8 is an illustration for explaining a state of assigning a license according to the present embodiment.

A description is give of a case where the device management server 10 assigns the license of the A-application to the 2000 devices 20. It is assumed that the usable number of the license of the A-application stored in the usable license information part 10B of the device management server 10 is 1000.

First, the device management server 10 finds the device 20 to which the license of the A-application is assigned. Here, it is assumed that the device management server 10 sequentially finds the devices 20-1, 20-2, 20-3, . . . in an order of the hyphenated numbers. It is also assumed that the 500 devices 20-1, . . . 20-500 do not require the license of the A-application and the 1500 devices 20-501, . . . 20-2000 require the license of the A-application.

The device management server 10 starts assigning of the license sequentially from the device 20-1 in an ascending order. Because the devices 20-1 to the device 20-500 do not require the license, the device management server 10 does not perform the assignment of the license. On the other hand, because the devices 20-501 to the device 20-2000 require the license, the device management server 10 performs the assignment of the license. At this time, the usable number of the license of the A-application in the usable license information part 10B is decremented by 1 for each time the license is assigned to the device 20. After the license of the A-application is assigned to the device 20-1500, the usable number of the license of the A-application becomes zero. Although the devices 20-1501 to 20-2000 require the license, the assignment of the license is not performed because the usable number of the license of the A-application is zero.

It should be noted that although the assignment of the license is performed in the order of finding the device 20, the order of assignment of the license is not limited to the order of finding the device 20. That is, the assignment may be performed in an order of a frequency of use of the device 20 in which the license is assigned first to the device 20 having the highest frequency of use. In this case, it is considered to retain a count value as a number of times of, for example, performing a copying process or a scanning process so as to perform the assignment of the license based on the count value.

Additionally, for example, the assignment of the license may be performed in an order designated by a user. That is, an order of assigning the license of the device 20 may be designated through a GUI screen or the like. Alternatively, an order of assigning the license may be designated by causing the device management server 10 to read a file in which an order of assignment of the license is designated.

Additionally, for example, it may be configured so that a user is allowed to designate an order of assigning the license only when the usable number of the license is zero.

A description will be given of the details of the above-mentioned license assigning process. FIG. 9 is a flowchart of the license assigning process according to the present embodiment.

First, 1 is substituted for 1 as an initial process, where N is a counter (step S301). Then, the process of step S S302 to S305 is repeated until N reaches a device find number or until the usable number of the license of the A-application becomes zero.

Then, it is determined whether the license of the A-application is required for the device 20-N (step S302). The case where the license of the A-application is required is a case where the license of the A-application of the device 20-N has already been made valid. As the case where the license of the A-application is not required, there may be a case where the A-application is not installed in the device 20-N.

If the license of the A-application is required for the device 20-1, the license of the A-application is assigned to the device 20-N (step S303). As a method of assigning the license, the process of steps S104 to S108 of the above-mentioned license validating process may be performed.

Then, the usable number of the license of the A-application stored in the usable license information part 10B is decremented by 1 (step S304), and N is incremented by 1 (step S305).

It should be noted that if the license of the A-application for the device 20-N in the process of step S302, the process of step S305 is performed.

Then, the above-mentioned process of steps S302 to S305 is performed for all of the devices 20 that have been found, or repeatedly performed until the usable number of the license of the A-application becomes zero.

As a method of finding the device 20 by the device management server 10, the device 20 can be found using the simple network management protocol (SNMP) with respect to a plurality of host names designated by a user. That is, the device 20 providing an SNMP response to an SNMP request may be set as an object to assign the license.

It should be noted that a determination whether the application to which the license assignment is applied is installed in the device 20 can be made by acquiring a list of installed applications of the device 20 with respect to the device 20 found by the above-mentioned method.

As mentioned above, the device management server 10 is capable of assigning a license of an application to a plurality of devices 20. Thereby, if the number of devices 20 managed by the device management server 10 is large, the validation of the license of the application can be performed conveniently.

As mentioned above, the device management system 1 according to the present embodiment can restrict an execution of the function of the device management server 10 when the license of the application is invalid. Thus, the application is prevented from being illegally used by, for example, restricting an operation of the application. Additionally, the device management server 10 can validate or invalidate a license of an application of the device 20. Thereby, the license of the application can be validated or invalidated even when the device 20 cannot communicate with the license server SV.

It should be noted that, in the above-mentioned embodiment, the device management server 10 is an example of a device management apparatus. The device license information part 10A is an example of a first storage part. The usable license information part 10B is an example of a second storage part. A license validating/invalidating part 16 is an example of a license validating part. The function execution possibility determining part 12 is an example of a function restricting part.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A device management apparatus comprising:
a first storage part storing license information regarding a license of an application for each of a plurality of devices; and
a processor executing a program to perform a license validating process and a function restricting process,
wherein the license validating process changes, when the license information includes invalidity information indicating that the license is invalid, the invalidity information into validity information indicating that the license is valid, and the function restricting process restricts, when the license information includes the invalidity information, an execution of a function of the device management apparatus with respect to the application of each of the devices.

2. The device management apparatus as claimed in claim 1, wherein the function of the device management apparatus is a process applied by the device management apparatus to the application of each of the devices based on an instruction by a user to the device management apparatus.

3. The device management apparatus as claimed in claim 1, further comprising a second storage part storing a license usable number indicating a number of times of authorized use of the license of each of the devices, wherein the license validating process changes the invalidity information into the validity information in response to the license usable number stored in the second storage part.

4. The device management apparatus as claimed in claim 3, wherein the license validating process changes the invalidity information into the validity information only when a number of pieces of validity information is smaller than the license usable number.

5. The device management apparatus as claimed in claim 1, wherein the processor executes a program to perform a device finding process of finding each of the devices that are connected to the device management apparatus through a network, and the license validating process changes the invalidity information into the validity information sequentially in an order of finding each of the devices by the device finding process.

6. The device management apparatus as claimed in claim 1, wherein the processor executes a program to perform a device designating process of designating one of more of the devices of which the license is to be validated, and the license validating process changes the invalidity information into the validity information sequentially in an order designated by the device designation process.

7. The device management apparatus as claimed in claim 1, further comprising a third storage part storing frequency information regarding frequency of use of each of the devices, wherein the license validating process changes the invalidity information into the validity information based on the frequency information sequentially in an order from one of the device of which frequency of use is highest.

8. A device management method of a device management apparatus connected to a plurality of devices through a network, the device management method comprising:
changing, when license information stored for each of the devices includes invalidity information indicating that the license is invalid, the invalidity information into validity information indicating that the license is valid; and
restricting, when the license information includes the invalidity information, an execution of a function of the device management apparatus with respect to an application of each of the devices.

9. A non-transitory computer readable recording medium storing a program causing a computer to perform a process to execute the device management method as claimed in claim 8.

10. A device management system comprising:
a plurality of devices;
a first storage part storing license information regarding a license of an application for each of the plurality of devices; and
a computer connected to the devices through a network, the computer executing a program to perform a license validating process and a function restricting process,
wherein the license validating process changes, when the license information includes invalidity information indicating that the license is invalid, the invalidity information into validity information indicating that the license is valid, and the function restricting process restricts, when the license information includes the invalidity information, an execution of a function of the computer with respect to the application of each of the devices.
